(19) United States
(12) Patent Application Publication
(10) Pub. No.: US 2006/0222358 A1
(43) Pub. Date: Oct. 5, 2006

(54) ELECTRONIC DEVICE HAVING A BARREL FOR COLLECTING SOUND

(76) Inventors: Jih-Yung Lu, Taipei Hsien (TW); Yung-Chin Cho, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/307,209

(22) Filed: Jan. 26, 2006

(30) Foreign Application Priority Data
Feb. 4, 2005 (TW) 094103657

(51) Int. Cl. G03B 17/18

(52) U.S. Cl. 396/283

(57) ABSTRACT

An electronic device having a barrel for collecting sound includes a housing, a speaker located inside the housing for generating sound, a plurality of holes formed on the housing for outputting the sound made by the speaker, and a barrel placed outside the housing corresponding to the region of the plurality of holes for collecting the sound output from the plurality of holes.

### BACKGROUND OF THE INVENTION

1. Field of the Invention

The present invention relates to an electronic device having a barrel for collecting sound, and more particularly, to an electronic device having a barrel for gathering sound output from a speaker.

2. Description of the Prior Art

Electronic products, such as digital cameras and digital video cameras, have a sound receiver and a speaker embedded inside the device so that a user can record and play sound or voice. Some of such products also can play movies or films from internal storage or broadcast. However, due to the limited size of these electronic products, they do not have enough space to collect sound before transmitting sound out from the electronic product, and thus, sound tone quality is not good.

Please refer to FIG. 1, which is a sectional drawing of a digital camera 100 based on the prior art. A housing 110 of the digital camera 100 has a plurality of holes 112. A speaker 120 is located inside the digital camera 100. Sound made by the speaker 120 travels through the holes 112. Since the size of the digital camera 100 is fixed, there is only a space 122 from the speaker 120 to the housing 110 used for collecting sound before the sound travels through the holes 112. However, the space 122 is very small and the efficiency of collecting sound is not good. Therefore, broadcast sound quality is poor and the volume is low.

### SUMMARY OF THE INVENTION

It is therefore a primary objective of the claimed invention to provide an electronic device having a barrel for collecting sound to solve the above-mentioned problem.

The claimed invention provides an electronic device having a barrel for collecting sound. The electronic device includes a housing, a speaker, a plurality of holes, and a barrel. The speaker is located inside the housing for generating sound. The plurality of holes is formed on the housing for outputting sound made by the speaker. The barrel is placed outside the housing corresponding to the region of the plurality of holes for collecting the sound output from the plurality of holes.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a sectional drawing of a digital camera based on the prior art.

FIG. 2 is a diagram of a first embodiment of the present invention.

FIG. 3 is a top view of the barrel of FIG. 2.

FIG. 4 and FIG. 5 are inner views of dotted-line area n of the housing of FIG. 2.

FIG. 6 and FIG. 7 are external views of dotted area n of the housing of FIG. 2.

FIG. 8 is a diagram of a second embodiment of the present invention.

FIG. 9 is a diagram of three cylinders of the telescopic barrel 320.

FIG. 10 is a cross-sectional diagram along line 10-10′ of FIG. 9.

FIG. 11 is a diagram of the telescopic barrel set into the housing of the electronic device.

FIG. 12 is a top view of the cylinder at the inner side and the column of the housing.

FIG. 13 is a diagram of the telescopic barrel extended out from the housing.

### DETAILED DESCRIPTION

In order to improve poor sound quality and low volume because of the small space for collecting sound, the present invention provides an electronic device having a barrel for collecting sound. When playing sound, the barrel located corresponding to the region of the holes is used for collecting sound output from the holes, such that the barrel gathers the sound before transmitting it to the listener. The principle is similar to a loudspeaker having a horn. The speaker resonates the air to generate sound waves. The sound waves are gathered by the horn, and then are transmitted far away. This method can enhance the volume of the sound and thereby the sound quality is clearer and the sound can travel further far away.

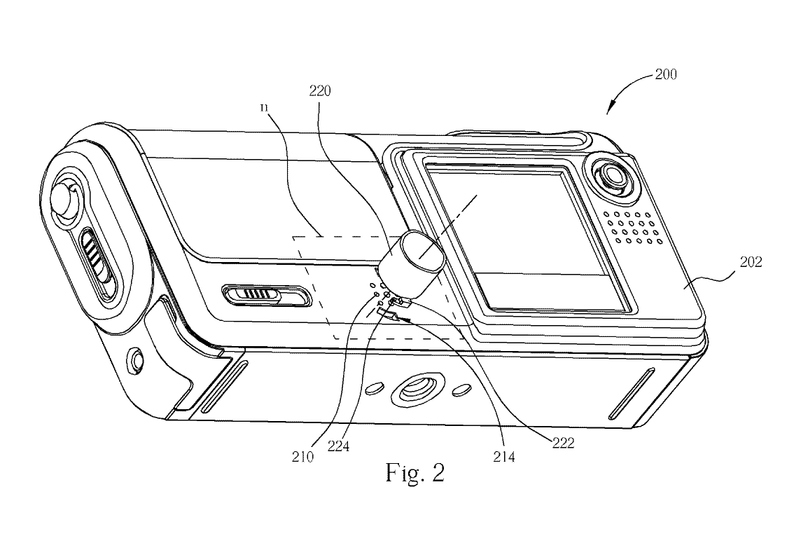

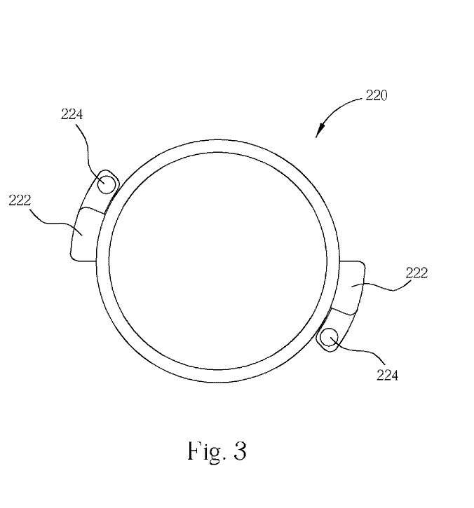

Please refer to FIG. 2, which is a diagram of a first embodiment of the present invention, namely, an electronic device 200 having a barrel 220. The barrel 220 of the electronic device 200 includes a plurality of holes 210. The barrel 220 is detachable from a housing 202 and serves to collect sound. The barrel 220 is engaged with the housing 202 by engaging elements (214, 222, and 224). The details are described in FIG. 3 to FIG. 5.

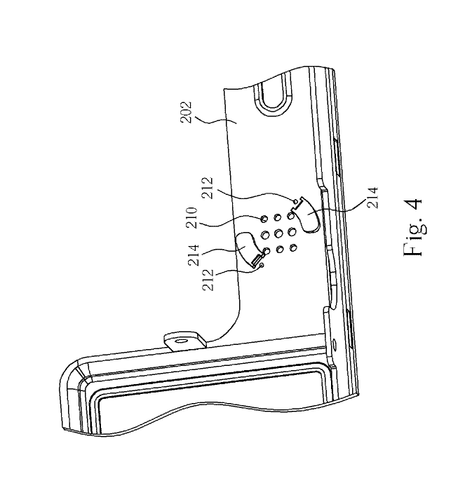

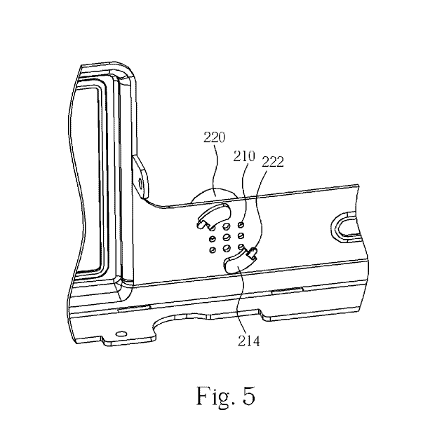

Please refer to FIG. 3, which is a top view of the barrel 220 of FIG. 2. The barrel 220 includes two pins 222, each pin 222 having a raised point 224 for engaging with the housing 202 of FIG. 2. Please refer to FIG. 4 and FIG. 5. FIG. 4 and FIG. 5 are inner views of area n (surrounded by a dotted line) of the housing 202 of FIG. 2. In addition to the holes 210, the housing 202 further includes two slots 214, each slot 214 having a pit 212 for engaging with the raised point 224 of the pin 222 of FIG. 3, such that the barrel 220 can be placed outside the electronic device 200. When the raised point 224 of the pin 222 engages with the pit 212 of the slot 214, the assembly of the barrel 220 and the electronic device 200 is complete, as shown in FIG. 5.

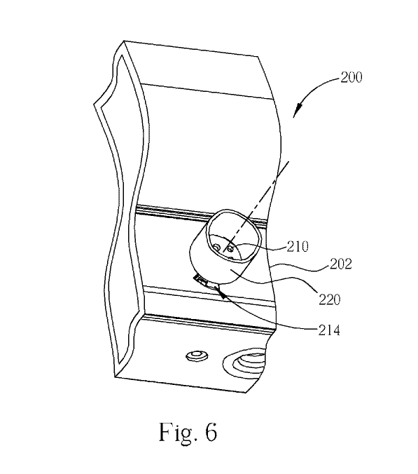

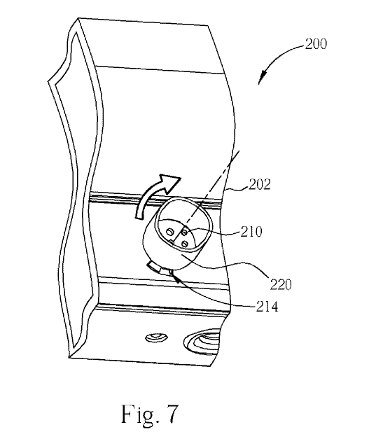

FIG. 4 and FIG. 5 are inner views of dotted-line area n of the housing 202 of FIG. 2. Please refer to FIG. 6 and FIG. 7, which are external views of the same dotted-line area n of the housing 202 of FIG. 2. When the pin 222 of the barrel 220 is inserted into the slot 214 of the housing 202, as shown in FIG. 6, the barrel 220 is rotated as shown in FIG. 7 so as to engage the raised point 224 of the pin 222 with the pit 212 of the slot 214 to complete the assembly.

The above is an embodiment of the pin 222 and the slot 214, but it is not limited to such. The pin 222 can include a pit and the slot 214 can include a raised point for the engagement. Other designs or methods, which can place the barrel 220 on the housing 202 of the electronic device 200, can be implemented in the present invention.

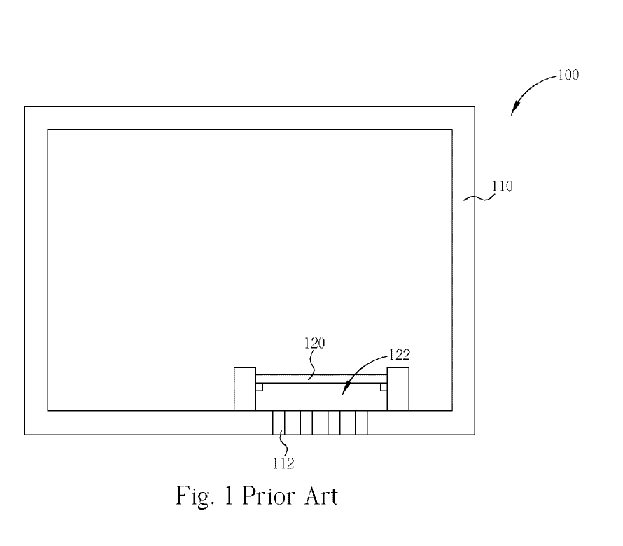

Additionally, the present invention takes full use of the space 122 (in FIG. 1) by providing an electronic device having a telescopic barrel embedded inside the original space 122. When playing sound, the user can pull out the telescopic barrel from the housing of the electronic device to expand the length of the barrel. Therefore, the sound quality is clearer after the barrel collects sound.

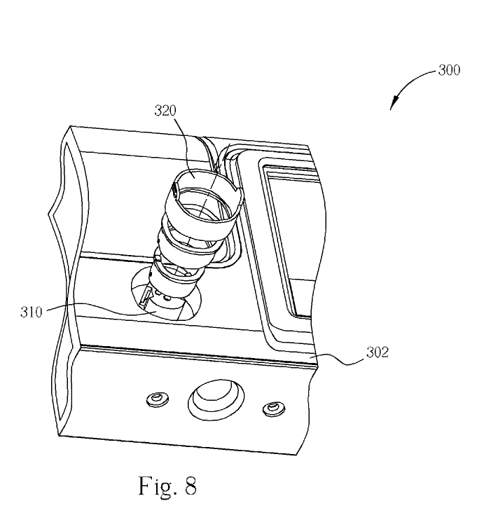

Please refer to FIG. 8, which is a diagram of a second embodiment of the present invention, an electronic device 300 having a telescopic barrel 320. A housing 302 of the electronic device 300 includes an opening 310. The telescopic barrel 320 is located inside the original space 122 (shown in FIG. 1). This embodiment uses the original space 122 to accommodate the telescopic barrel 320, and recesses the opening 310 into the housing 302 of the electronic device 300. When playing sound, the telescopic barrel 320 can be extended out of the housing 302 to increase the length of the barrel 320 for collecting sound.

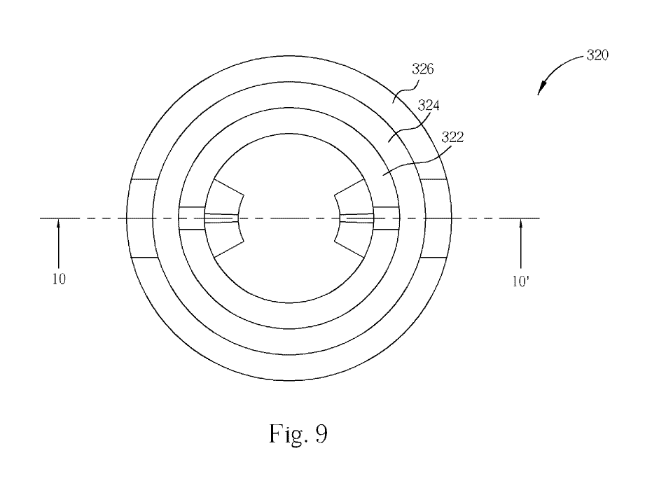

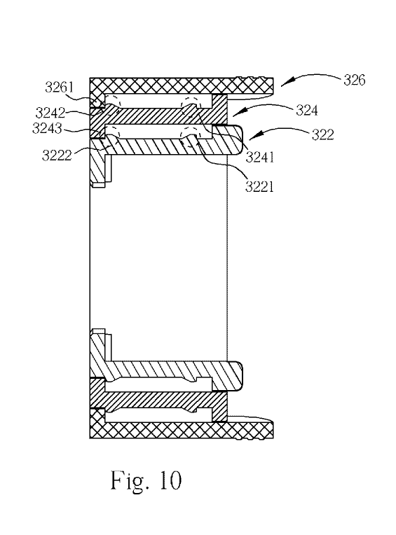

The following is the structure of the telescopic barrel 320. The telescopic barrel 320 includes a plurality of cylinders. This embodiment includes three cylinders; however, the number of cylinders can be less than or more than three. Please refer to FIG. 9 and FIG. 10. FIG. 9 is a diagram of three cylinders of the telescopic barrel 320. FIG. 10 is a cross-sectional diagram along line 10-10′ of FIG. 9. As shown in FIG. 10, the cylinder 322 has two ribs 3221 and 3222; the cylinder 324 has two ribs 3241 and 3242, and a hook 3243; and the cylinder 326 only has a hook 3261. When the telescopic barrel 320 is not pulled out of the housing 302, the rib 3222 of the cylinder 322 engages with the hook 3243 of the cylinder 324 to prevent the cylinder 324 from sliding out. Similarly, the rib 3242 of the cylinder 324 engages with the hook 3261 of the cylinder 326 to prevent the cylinder 326 from sliding out.

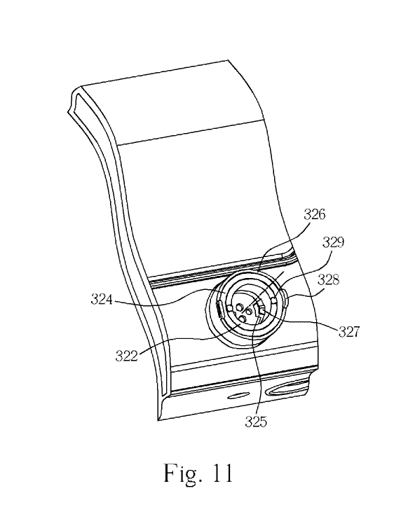

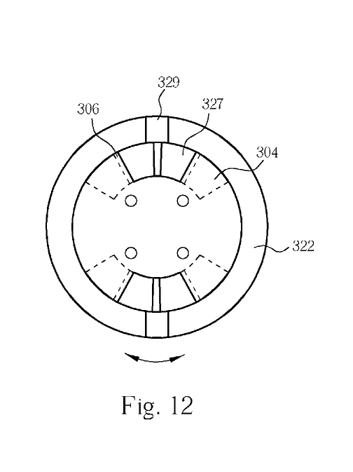

Regarding the assembly of the telescopic barrel 320 and the electronic device 300, please refer to FIG. 11. FIG. 11 is a diagram of the telescopic barrel 320 set into the housing 302 of the electronic device 300. The housing 302 includes a trench 325, and the cylinder 322 further includes a hook 327 and two protrusions 329. The hook 327 of the telescopic barrel 320 is aimed at the trench 325 for placing the telescopic barrel 320 into the housing 302. Please refer to FIG. 12, which is a top view of the cylinder 322 at the inner side and the column of the housing 302. After the barrel 320 is placed inside the housing 302, the hook 327 of the cylinder 322 is lower than the plane of the holes. There is a track 304 inside the column (dotted line) for the hook 327 to slide on. Additionally, there is a recess 306 (dotted line) at each side of the track 304 for engaging with the hook 327. Therefore, the hook 327 of the cylinder 322 can slide on the track 304 and engage with the recess 306 of the track 304 by rotating the protrusion 329 of the cylinder 322 clockwise or counterclockwise (as shown by an arrow), such that the barrel 320 can be fixed inside the housing 302.

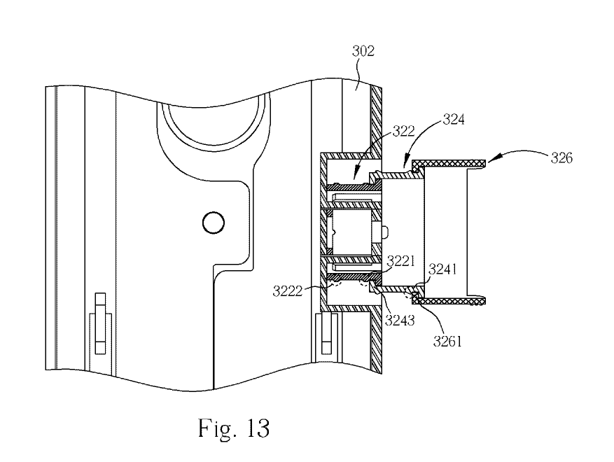

In addition, as shown in FIG. 11, the cylinder 326 further includes two protrusions 328. The user can use the two protrusions 328 to pull out the barrel 320 easily. Please refer to FIG. 1 3, which is a diagram of the telescopic barrel 320 extended out from the housing 302. When the telescopic barrel 320 is pulled out, the rib 3221 of the cylinder 322 engages with the hook 3243 of the cylinder 324, and the rib 3241 of the cylinder 324 engages with the hook 3261 of the cylinder 326, so that the cylinders 322, 324, and 326 are not separated from each other, as shown in FIG. 13.

In the second embodiment, the cylinder 322 is fixed inside the space 122. No matter whether the telescopic barrel 320 is pulled out or pushed inside the housing 302, the cylinder 322 is always inside the housing 302. Only cylinders 324 and 326 are extended out from the housing 302 to increase the length of the telescopic barrel 320.

In addition to the above two embodiments, according to the spirit of the present invention, the external barrel 220 of the first embodiment (in FIG. 2) can be formed along with the housing 202, rather than being externally connected to the housing 202. Also, the telescopic barrel 320 of the second embodiment (in FIG. 8) can be fixed inside or detachable from the housing 302.

The present invention can be implemented in a digital camera, a personal data assistant (PDA), a mobile phone, a recording pen, an MP3 player, a liquid crystal display (LCD), or a digital video camera. Compared to the prior art, the present invention adopts an external barrel or adds a barrel to the original speaker location for collecting sound before it is transmitted to the user. The present invention can improve the sound quality and the volume can become louder and the sound clearer.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device having a barrel for collecting sound, the electronic device comprising:
a housing;
a speaker located inside the housing for generating sound;
a plurality of holes formed on the housing for outputting the sound made by the speaker; and
a barrel placed outside the housing corresponding to the region of the plurality of holes for collecting the sound output from the plurality of holes.

2. The electronic device of claim 1, wherein the barrel is detachable from the housing.

3. The electronic device of claim 2 further comprising a connector for engaging the barrel with the housing, the connector comprising a pin and a slot for receiving the pin.

4. The electronic device of claim 3, wherein the pin is formed on the barrel, and the slot is formed on the housing.

5. The electronic device of claim 3, wherein the pin includes a raised point, and the slot includes a pit for engaging with the raised point.

6. The electronic device of claim 3, wherein the pin includes a pit, and the slot includes a raised point for engaging with the pit.

7. The electronic device of claim 1, wherein the barrel includes a plurality of cylinders, one of the cylinders fixed on the housing and the other cylinders for extending out from the housing for increasing the length of the barrel.

8. The electronic device of claim 7, wherein for any two adjacent cylinders, the cylinder at inner side has a rib and the cylinder at outer side has a hook for engaging with the rib of the inner cylinder.

9. The electronic device of claim 7, wherein the housing further comprises an opening, the plurality of cylinders of the barrel being selectively inside the opening or extended out of the housing in a telescopic manner.

10. The electronic device of claim 1 being a digital camera, a personal data assistant (PDA), a mobile phone, a recording pen, an MP3 player, a liquid crystal display (LCD), or a digital video camera.
